(19) United States
(12) Patent Application Publication
(10) Pub. No.: US 2010/0265889 A1
(43) Pub. Date: Oct. 21, 2010

(54) METHOD FOR RECOGNIZING POSITIONS OF A PLURALITY OF NODES WHICH CONSIST WIRELESS SENSOR NETWORK

(76) Inventors: Jong-Jun Park, Kyungsangbuk-do (KR); Sang-Joon Park, Kyungsangbuk-do (KR); Cheol-Sig Pyo, Daejeon-city (KR); Jong-Suk Chae, Daejeon-city (KR)

Correspondence Address: STAAS & HALSEY LLP, SUITE 700, 1201 NEW YORK AVENUE, N.W., WASHINGTON, DC, 20005, US

(21) Appl. No.: 12/808,528

(22) PCT Filed: May 22, 2008
(86) PCT No.: PCT/KR08/02856

§ 371 Date: Jun. 16, 2010

(30) Foreign Application Priority Data
Dec. 17, 2007 (KR) 10-2007-0132706

(51) Int. Cl. H04W 40/00

(52) U.S. Cl. 370/328

(57) ABSTRACT

A method for recognizing positions of a plurality of nodes which constitute a wireless sensor network is provided, the method comprises generating sub-maps which represent the relative position to neighbor nodes by taking each of the plurality of nodes as a reference; selecting a sub-map which takes a node with the highest connectivity as a reference from among the plurality of nodes; selecting a sub-map which takes a node with the highest connectivity as a reference, except for the node which becomes a reference of the selected sub-map among the nodes which are included in the selected sub-map; integrating the selected sub-maps into one map by matching the same nodes among the nodes which are commonly included in the selected sub-maps; and thereafter correcting positions of nodes which are included in the integrated map to real positions, whereby integrating order of the sub-map is adjusted using an information of the connectivity of the nodes, and the positions of the nodes which constitute the wireless sensor network is constituted are correctly recognized by correcting the position of the nodes.

### CROSS-REFERENCE TO RELATED PATENT APPLICATION

This application claims the benefit of Korean Patent Application No. 10-2007-0132706, filed on Dec. 17, 2007, in the Korean Intellectual Property Office, the disclosure of which is incorporated herein in its entirety by reference.

### BACKGROUND OF THE INVENTION

1. Field of the Invention

The present invention relates to a method for recognizing positions of a plurality of nodes which consist a wireless sensor network.

The present invention is derived from a research project supported by the Information Technology (IT) Research & Development (R&D) program of the Ministry of Information and Communication (MIC) and the Institute for Information Technology Advancement (IITA) [2005-S-038-03, Development of UHF RF-ID and Ubiquitous Networking Technology].

2. Description of the Related Art

Generally, wireless sensor network consists of a plurality of nodes. In order to provide a position-based service or more effectively apply data in such wireless sensor network, the positions of nodes which constitute the wireless sensor network should be known. That is, in a wireless sensor network environment in which the plurality of nodes are disorderly distributed in a condensed form, even when the number of anchor nodes that their own positions are known is less than the number of nodes that their own positions are not known, positions of all nodes should be grasped.

Conventionally, a Multi-dimensional Scaling (MDS) had been used as a method for recognizing positions of nodes. In principle, the Multi-dimensional Scaling means a method which when dissimilarity or similarity between objects is given to n objects, allows n points having distance between points being likely to be matched to the dissimilarity to be positioned in a space of any dimension. If the method is used in recognizing position information, the positions of the nodes can be recognized. However, in order to apply the Multi-dimensional Scaling, the distance between all nodes should be known, and in order to know the distance between all nodes, a multi-hop distance between nodes should be known using a shortest path algorithm. However, when the network distribution is irregular so that holes exist, the error of the multi-hop distance becomes very large, so that the accuracy is lower. In addition, when the nodes are very much, there is a problem that network traffic is increased in order to obtain all data which is required

As a solution to solve this problem, a distributed Multi-dimensional Scaling (distributed MDS) which is one of distributed position recognition schemes had been studied. The distributed Multi-dimensional Scaling means a method that each node uses distance information between nodes which are around its own node to generate a sub-map, and thereafter to incorporate each sub-map into a global map. According to the distributed Multi-dimensional Scaling (distributed MDS), there is an advantage that since only information in the order of 1 hop or 2 hops is used, there is no an effect by the hole even in the environment where the hole exist, and since computation amount is reduced, the network traffic is decreased and a processing speed is improved.

However, there is a problem that since the distributed Multi-dimensional Scaling did not explain a specific scheme for incorporating the sub-maps, correct positions of nodes which constitute the wireless sensor network are not recognized.

### SUMMARY OF THE INVENTION

The present invention provides a method for recognizing positions of a plurality of nodes which constitute a wireless sensor network, and more particular, a method for correctly recognizing positions of a plurality of nodes which constitute a wireless sensor network by suggesting a specific method which incorporates sub-maps in the distributed Multi-dimensional Scaling.

According to an aspect of the present invention, there is provided there is provided a method for recognizing positions of a plurality of nodes which constitute a wireless sensor network, comprising; generating sub-maps which represent the relative position to neighbor nodes by taking each of the plurality of nodes as a reference; selecting a sub-map which takes a node with the highest connectivity as a reference from among the plurality of nodes; selecting a sub-map which takes a node with the highest connectivity as a reference, except for the node which becomes a reference of the selected sub-map among the nodes which are included in the selected sub-map; integrating the selected sub-maps into one map by matching the same nodes among the nodes which are commonly included in the selected sub-maps; and correcting positions of nodes which are included in the integrated map to real positions.

In order to solve this technical problem, there is provided a computer readable recording medium on which a program for executing the method for recognizing the position of the plurality of nodes which constitute the wireless sensor network according to the present invention by a computer is recorded.

The method for recognizing positions of a plurality of nodes which constitute a wireless sensor network according to the present invention, comprising; generating sub-maps which represent the relative position to neighbor nodes by taking each of the plurality of nodes as a reference; selecting a sub-map which takes a node with the highest connectivity as a reference from among the plurality of nodes; selecting a sub-map which takes a node with the highest connectivity as a reference, except for the node which becomes a reference of the selected sub-map among the nodes which are included in the selected sub-map; integrating the selected sub-maps into one map by matching the same nodes among the nodes which are commonly included in the selected sub-maps; and thereafter correcting positions of nodes which are included in the integrated map to real positions, whereby there are effects that integrating order of the sub-map is adjusted using an information of the connectivity of the nodes, and the positions of the nodes which constitute the wireless sensor network can be correctly recognized by correcting the position of the nodes.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating a wireless sensor network consisting of nodes which are disorderly distributed according to an embodiment of the present invention;

FIG. 2 is a flow chart illustrating a method for recognizing positions of a plurality of nodes which constitute the wireless sensor network according to an embodiment of the present invention;

FIGS. 3A and 3B are sub-maps generated according to an embodiment of the present invention;

FIG. 4 is a table showing connectivity of nodes which constitute the wireless sensor network as illustrated in FIG. 1 according to an embodiment of the present invention;

FIG. 5 is a sub-map which is used as an integration reference selected according to an embodiment of the present invention;

FIG. 6 is a map generated by integrating sub-maps according to an embodiment of the present invention; and

FIG. 7 is a map generated by integrating the sub-maps and the map integrated according to an embodiment of the present invention.

### DETAILED DESCRIPTION OF THE INVENTION

The present invention will now be described more fully hereinafter with reference to the accompanying drawings, in which exemplary embodiments of the invention are shown. This invention may, however, be embodied in many different forms and should not be construed as being limited to the embodiments set forth herein. Rather, these embodiments are provided so that this disclosure will be thorough and complete, and will fully convey the scope of the invention to those skilled in the art. Like numbers refer to like elements throughout the specification.

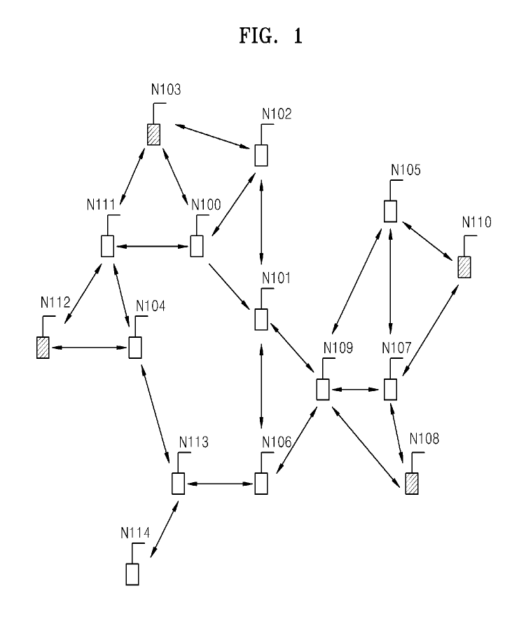

FIG. 1 is a diagram illustrating a wireless sensor network consisting of nodes which are disorderly distributed.

Generally, the nodes which constitute the wireless sensor network are disorderly distributed as shown in FIG. 1. In FIG. 1, nodes N103, N108, N110, and N112 which are represented by hatched lines refer to anchor nodes for which absolute positions are known.

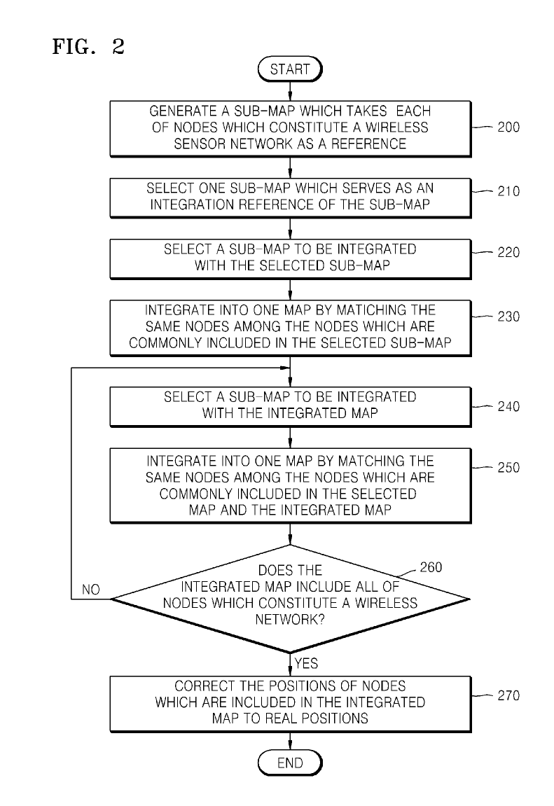

FIG. 2 is a flow chart illustrating a method for recognizing positions of a plurality of nodes which constitute the wireless sensor network according to an embodiment of the present invention.

Hereinafter, referring to the wireless sensor network as shown in FIG. 1, a procedure which is performed in FIG. 2 will be described in detail.

In STEP 200, a sub-map which takes each of nodes which constitutes the wireless sensor network as a reference is generated. Then, the sub-map means to take one node as a reference to thereby represent the relative positions to neighbor nodes. Accordingly, the sub-map would be constructed by measuring the relative distance to the neighbor node, for each of the plurality of nodes which constitute the wireless sensor network.

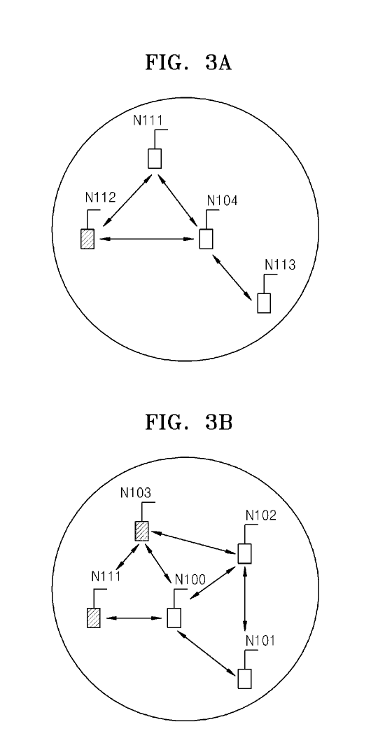

FIGS. 3A and 3B are sub-maps generated according to an embodiment of the present invention.

FIG. 3A is a sub-map which is generated by taking a node N104 as a reference in the wireless sensor network in FIG. 1, and FIG. 3B is a sub-map which is generated by taking a node N100 as a reference in the wireless sensor network in FIG. 1. As shown in FIGS. 3A and 3B, relative positions of neighbor nodes (N111, N112, and N113 in FIG. 3A, and N101, N102, N103, and N111 in FIG. 3B) can be represented on the sub-map by taking one node (N104 in FIG. 3A, and N100 in FIG. 3B) as a reference. In an embodiment of the present invention, the sub-maps in which the node N104 and the node N100 are taken as a reference are represented in FIGS. 3A and 3B, however, the sub-map for each of the plurality of nodes which constitute the wireless sensor network can be constructed.

Referring to FIG. 2 again, in STEP 210, one sub-map which is used as integration reference of the sub-map is selected. That is, one sub-map which is used as integration reference of the sub-map is selected from among the generated sub-maps, wherein a sub-map which takes a node with the connectivity being higher as a reference is selected in a first order. Generally, the connectivity of the nodes which constitute the wireless sensor network varies depending on the nodes. The sub-map which takes the node with the highest connectivity among the nodes as a reference is selected as the sub-map which will be used as an integration reference of the sub-map. Then, the connectivity means the number of nodes which are within a range in which a distance measurement on a specific node is possible, in case of taking a particular node as a reference. For example, in case of ultrasonic, the connectivity refers to the number of nodes which can transmit/receive an ultrasonic signal. Thus, if the connectivity is higher, the degree of aggregation becomes higher, because the nodes are close each other. The reason that the node with the connectivity being higher takes as the first order, is because the higher the connectivity is, the higher the accuracy become.

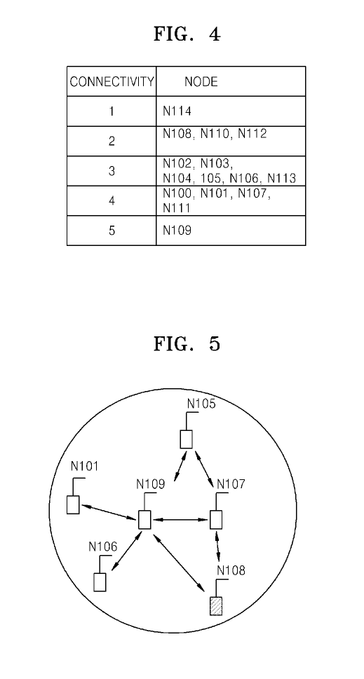

FIG. 4 is a table showing connectivity of nodes which constitute a wireless sensor network as illustrated in FIG. 1 according to an embodiment of the present invention.

The connectivity means the number of nodes which are within a range in which a distance measurement on a specific node is possible, in case of taking a specific node as a reference, and the connectivity of nodes as illustrated in FIG. 1 has various values from 1 to 5 as shown in FIG. 4. According to an embodiment of the present invention, since the sub-map which takes the node with the connectivity being higher as a reference is selected, in STEP 210, the sub-map which takes the node N109 with the highest connectivity, five (5) as shown in FIG. 4 as a reference is selected.

FIG. 5 is a sub-map which is used as an integration reference selected according to an embodiment of the present invention. The sub-map selected according to the embodiment of the present invention is the same as that shown in FIG. 5. That is, according to the embodiment of the present invention, the sub-map which takes a node N109 with the highest connectivity from among nodes which constitute the wireless sensor network as shown in FIG. 1 as a reference is selected in STEP 210, and the selected sub-map is the same as that shown in FIG. 5.

According to the embodiment of the present invention, although the node with the highest connectivity is only one, and when nodes with the most connectivity exist two or more, a sub-map which takes the nodes with the highest mean value of the connectivity of the neighbor nodes among the nodes with the highest connectivity as a reference is selected as a sub-map which will be used as an integration reference. For example, when the connectivity of the node with the highest connectivity is 10 and node with the connectivity being 10 exists two or more, a sub-map which determines the mean value of the connectivity of 10 nodes, which are neighbor nodes and takes a node with the highest value as a reference is selected. Then, the neighbor nodes refer to nodes which are located within the range in which a distance measurement on the reference node is possible. Therefore, the connectivity is identical with the number of the neighbor nodes.

Furthermore, if nodes with mean values of the connectivity of the neighbor nodes being identical with each other exist two or more, the sub-map which takes the node which is at the closest position from an anchor node as a reference is selected. That is, a sub-map which takes a node with their divergence values being lowest as a reference is selected by comparing hop number from the anchor node for which an absolute position is known.

Referring to FIG. 2 again, a sub-map to be integrated with the selected sub-map is selected in STEP 220. The sub-map in which the node with the highest connectivity among the nodes which are included in the sub-map is taken as a reference is selected, excepting for one sub-map which will be used as an integration reference of the sub-maps. Referring to FIG. 4, in the sub-map in which the node N109 is taken as a reference, the nodes with the highest connectivity are nodes N101 and N107, for which the connectivity is “4”, among the nodes excepting for the N109. Thus, when the nodes with the highest connectivity exists two or more, a sub-map which takes a node with the highest mean value of the connectivity of neighbor nodes among these nodes as a reference is selected. Neighbor nodes of the node N101 are N100, N102, N106, and N109, and neighbor nodes of node N107 are N105, N108, N109, and N110. Referring to the connectivity of the nodes as shown in FIG. 4, mean value of the connectivity of the neighbor nodes N100, N102, N106, and N109 of the node N101 is (4+3+3+5)/4, that is, 3.75, and mean value of the connectivity of the neighbor nodes N105, N108, N109, and N110 of the node N107 is (3+2+5+2)/4, that is, 3. Accordingly, since the mean value of the connectivity of the neighbor node of the node N101 is higher than that of the connectivity of the neighbor node of the node N107, a sub-map to be integrated with the sub-map selected in STEP 210, to which the node N101 belongs, is selected in STEP 220.

According to an embodiment of the present invention, the node with the mean value of the connectivity of the neighbor node being higher is one. However, if nodes with the mean value of the connectivity of the neighbor nodes being identical with each other exist two or more, a sub-map which takes a node which is at the closest position from the anchor node from among these nodes as a reference is selected. That is, a sub-map which takes a node with a divergence value being the lowest value as a reference is selected by comparing hop number from the anchor node for which an absolute position is known.

In STEP 220, the sub-map to be integrated with the sub-map selected in STEP 210 according to the reference as described above is selected. In such case, at least two same nodes should be included into all of the sub-maps, and preferably, three same nodes should be included into all of the sub-maps. If the sub-map which takes the node N101 as a reference is selected in STEP 220 according to an embodiment of the present invention, the same nodes N101, N106, and N109 are included in all of sub-maps, so that the condition which is required to integrate the sub-map is satisfied.

In STEP 230, the same nodes among nodes which are commonly included in the selected sub-maps are matched to be integrated into one map.

According to the embodiment of the present invention, when a sub-map which takes the node N109 as a reference is selected through STEP 210 and a sub-map which takes the node N101 as a reference are selected through STEP 220, since the nodes N101, N106, and N109 are included into the sub-maps, their nodes are matched with each other to be integrated into one map.

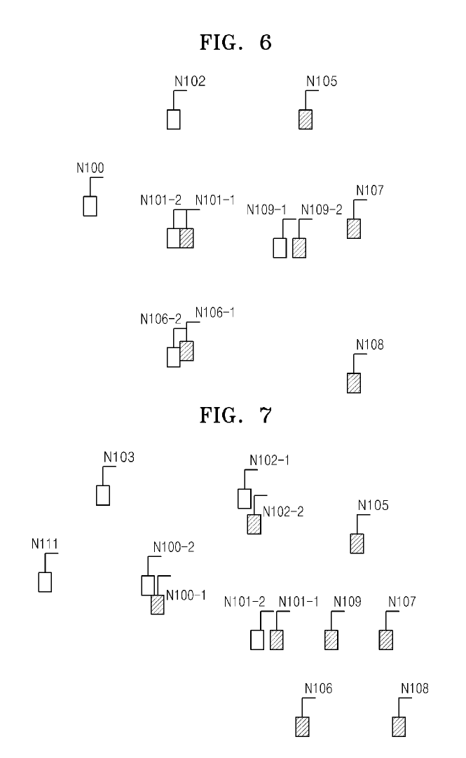

FIG. 6 is a map showing a map generated by integrating sub-maps according to an embodiment of the present invention.

If the sub-map which takes the node N109 as a reference and the sub-map which takes the node N101 as a reference are integrated, it will be the same as that as shown in FIG. 6. Then, since the positions of the nodes in the map in which the node N109 is taken as a reference and the positions of the nodes in the map in which the node N101 is taken as a reference are different with each other, the nodes N101, N106, and N109 which are commonly included in the sub-maps, are not matched completely. Accordingly, the sub-maps are moved and rotated such that the nodes N101, N106, and N109 are be overlapped to the utmost so that their positions are adjusted. Then, a position adjustment is depended on the position of the sub-map with the connectivity being higher. Accordingly, according to the embodiment of the present invention, since the connectivity of the sub-map which takes the node N109 as a reference is higher, the position of the nodes which are commonly included in the sub-map is adjusted based on the position of the sub-map which takes the node N109 as a reference. If the sub-maps are integrated through STEP 230, the connectivity of the integrated sub-maps is a mean value of the connectivity of the sub-maps to be integrated. That is, according to the embodiment of the present invention, the connectivity of the sub-map which takes the node N109 as a reference is 5, and the connectivity of the sub-map which takes the node N101 as a reference is 4, and therefore, the connectivity of the map which is generated by integrating the sub-maps becomes 4.5. That is, the connectivity of the map as shown in FIG. 6 becomes 4.5.

In STEP 240, a sub-map to be integrated with the map which is integrated through STEP 230 is selected. That is, a sub-map which takes the node according to a predetermined order among the nodes included in the integrated map as a reference is selected as a sub-map to be integrated with the integrated map in STEP 240. Herein, regarding to the predetermined order, a node with the highest connectivity among the nodes except for the nodes which is used as a reference of the integrated map is defined as the first order, and if the nodes with the highest connectivity exist two or more, a node with the highest mean value of the connectivity of the neighbor nodes among the nodes with the highest connectivity is defined as the second order, and if the nodes with the highest mean value of the connectivity of the neighbor nodes exist two or more, the node which is at the closest position from the anchor node among the nodes with the highest mean value of the connectivity of the neighbor nodes is defined as the third order. Accordingly, in STEP 240, a sub-map to be integrated with the map which is integrated according to the order as described above is selected.

In selecting the sub-map to be integrated with the map integrated in STEP 240, the nodes with the highest connectivity among the nodes ranked in the first order which are included in the integrated map are the node N100 and the node N107, of which the connectivity are 4. Therefore, according to the second order, mean value of the connectivity of the nodes N101, N102, N103, and N111 which are neighbor nodes of the node N100 is (4+3+3+4)/4, that is 3.5, and mean value of the connectivity of the nodes N105, N108, N109, and N110 which are neighbor nodes of the node N107 is (3+2+5+2)/4, that is 3. Therefore, in STEP 240, a sub-map which takes the node N100 as a reference is selected.

In STEP 250, the same nodes among the nodes which are commonly included in the map which is selected through STEP 240 and the map which is integrated through STEP 230 are matched to be integrated into one map.

The map integrated through STEP 230 according to the embodiment of the present invention is the same as shown in FIG. 6, and if the sub-map which takes the node N100 as a reference through STEP 240 is selected, since the nodes N100, N101, and N102 are commonly included into the map integrated with the sub-map, they are matched with each other to be integrated in one map.

FIG. 7 is a map generated by integrating the sub-maps and the map integrated according to an embodiment of the present invention.

That is, if the map integrated through STEP 250 and the sub-map are integrated, it is the same as that as shown in FIG. 7. Then, positions of the nodes N100, N101, and N102 in the integrated map and the sub-map are different to each other, the nodes N100, N101, and N102 are not matched completely. Accordingly, the sub-maps are moved and rotated such that the nodes N100, N101, and N102 are overlapped to the utmost, so that their positions are adjusted. Then, the position adjustment is depended on the position of the map with the higher connectivity.

In STEP 260, it is confirmed whether the map integrated through STEP 250 include all of nodes which constitute the wireless network. As a result of the confirmation, if the integrated map does not include all of nodes which constitute the wireless network, STEP 240 is performed again, and if the integrated map includes all of the nodes which constitute the wireless network, STEP 270 is performed. Thus, STEP 240 and STEP 250 according to the embodiment of the present invention are repeatedly performed until the integrated map will include all of the nodes which constitute the wireless network.

In STEP 270, the positions of the nodes which are included in the integrated map are corrected to real positions. That is, after integrating the sub-maps to construct one map, the positions of the nodes which are included in the integrated map are corrected to real positions by performing linear transformation using the real position values of the anchor nodes.

In addition, after integrating the sub-maps, as a result of comparing the connectivity of the reference node and the neighbor nodes with the connectivity of the integrated one map, when it is beyond the standard deviation range, the position of the reference node is re-adjusted. If only the position of the nodes which are within the standard deviation region among the neighbor nodes when re-adjusting is taken as a reference, the position is re-adjusted by using a technique, such as an weighted least square estimation, using the relative position of their nodes and the distance value.

Meanwhile, the embodiment of the present invention as described above can be made by a program which can be executed in the computer and can be implemented by a general purpose digital computer for executing the computer program using a computer readable recording medium.

In addition, a data structure used in the embodiment of the present invention as described above can be recorded on a computer readable recording medium by various means.

The computer readable recording medium may comprise a magnetic storage medium (for example, a random access memory (ROM), a floppy disk, and a hard disk etc.), an optical read medium (for example, a compact disk (CD) ROM, and a digital versatile disk (DVD) etc.), and a storage medium such as a carrier wave (for example, transmission through internet).

Hereto the present invention has been particularly shown and described with reference to exemplary embodiments thereof. It will be understood by those of ordinary skill in the art that the present invention can be implemented in modified forms within departing from the essential nature of the present. Therefore, embodiments disclosed should be considered in view of illustration, not in view of limitation. The scope of the present invention is defined by the following claims, not the above description, and all difference which is within a scope being equivalent to with it should be construed to be included in the present invention.

What is claimed is:

1. A method for recognizing positions of a plurality of nodes which constitute a wireless sensor network, comprising;
generating sub-maps which represent the relative position to neighbor nodes by taking each of the plurality of nodes as a reference;
selecting a sub-map which takes a node with the highest connectivity as a reference from among the plurality of nodes;
selecting a sub-map which takes a node with the highest connectivity as a reference, except for the node which becomes a reference of the selected sub-map among the nodes which are included in the selected sub-map;
integrating the selected sub-maps into one map by matching the same nodes among the nodes which are commonly included in the selected sub-maps; and
correcting positions of nodes which are included in the integrated map to real positions.

2. The method of claim 1, wherein the selecting a sub-map which takes a node with the highest connectivity as a reference from among the plurality of nodes further comprising:
if nodes with the highest connectivity among the plurality of nodes exist two or more,
selecting a sub-map which takes a node with the highest mean value of the connectivity of the neighbor nodes as a reference from among the nodes with the highest connectivity.

3. A method of claim 2, wherein the selecting a sub-map which takes a node with the highest mean value of the connectivity of the neighbor nodes as a reference from among the nodes with the highest connectivity further comprising:
if nodes with the highest mean value of the connectivity of the neighbor nodes exist two or more,
selecting a sub-map which takes a node which is at the closest position from an anchor node as a reference among the nodes with the highest mean value of the connectivity of the neighbor nodes.

4. The method of claim 1, wherein the selecting a sub-map which takes a node with the highest connectivity as a reference, except for the node which becomes a reference of the selected sub-map among the nodes which are included in the selected sub-map further comprising:
if the nodes with the highest connectivity among the nodes which are included in the selected sub-map are two or more,
selecting a sub-map which takes the node with the highest mean value of the connectivity of the neighbor nodes as a reference from among the nodes with the highest connectivity.

5. The method of claim 4, the selecting a sub-map which takes the node with the highest mean value of the connectivity of the neighbor nodes as a reference from among the nodes with the highest connectivity further comprising:
if the nodes with the highest mean value of the connectivity of the neighbor nodes exist two or more,
selecting a sub-map which takes a node which is at the closest position from an anchor node as a reference among the nodes with the highest mean value of the connectivity of the neighbor nodes.

6. The method of claim 1, wherein the integrating the selected sub-maps into one map by matching the same nodes among the nodes which are commonly included in the selected sub-maps comprises:
integrating the selected sub-maps into one-map by matching a position of the node with higher connectivity among the same nodes to a position of different node.

7. The method of claim 1, wherein the correcting positions of nodes which are included in the integrated map to real positions comprises:
correcting positions of nodes which constitute the integrated map to absolute positions using an anchor node of the plurality of nodes.

8. The method of claim 1, further comprising: after the integrating the selected sub-maps into one map by matching the same nodes among the nodes which are commonly included in the selected sub-maps,
integrating the selected sub-maps into one map by matching the same nodes among the nodes which are included in the sub-map which takes a node according to a predetermined order among the nodes included in the integrated map as a reference and the integrated map.

9. The method of claim 8, wherein the predetermined order is determined by:
ranking the node with the highest connectivity among the nodes except for the node which is used as a reference in the integrated map as the first order;
if the nodes with the highest connectivity exist two or more, ranking the node with the highest mean value of the connectivity of the neighbor nodes among the nodes with the highest connectivity as the second order; and
if the nodes with the highest mean value of the connectivity of the neighbor nodes exist two or more, ranking the node which is at the closet position from the anchor node among the nodes with the highest mean value of the connectivity of the neighbor node as the third node.

10. The method of claim 9, wherein the integrating the selected sub-maps into one map by matching the same nodes among the nodes which are included in the sub-map which takes a node according to a predetermined order among the nodes included in the integrated map as a reference and the integrated map is performed until the map which is integrated includes all of the plurality of nodes.
